(19) United States
(12) Patent Application Publication
(10) Pub. No.: US 2012/0117260 A1
(43) Pub. Date: May 10, 2012

(54) Enhanced Diameter Gateway

(75) Inventors: David F. Ropelewski, Palatine, IL (US); Russell E. Sorber, Oak Park, IL (US)

(73) Assignee: Infinite Convergence Solutions, Inc, Arlington Heights, IL (US)

(21) Appl. No.: 13/289,745

(22) Filed: Nov. 4, 2011

Related U.S. Application Data
(60) Provisional application No. 61/411,913, filed on Nov. 9, 2010.

(51) Int. Cl. G06F 15/16

(52) U.S. Cl. 709/230

(57) ABSTRACT

The invention is an apparatus that performs Diameter protocol routing as well as real-time Diameter protocol capture and display in a telecommunications network. The improvement over the prior art enables the network operator to quickly determine routing errors in their network and minimize network interruptions without purchase and configuration of additional test tools.

### CROSS-REFERENCE TO RELATED APPLICATIONS

This application claims the benefit of provisional patent application Ser. No. 61/411,913 filed 2010 Nov. 9 by the present inventors.

### FEDERALLY SPONSORED RESEARCH

None.

### SEQUENCE LISTING

None.

### FIELD OF THE INVENTION

This relates to telecommunications infrastructure in general and to the routing and display of diameter network protocol messages in particular.

### BACKGROUND OF THE INVENTION

In RFC 3588, the Internet Engineering Task Force (IETF) developed the Diameter Base Protocol to facilitate communication between telecommunication network elements to especially address Authentication, Authorization and Accounting functions. Diameter protocol has since been extended to add new commands and attribute-value pairs (AVPs) to create Diameter Application protocols. Diameter Application protocols currently enable services such as IP Multimedia Systems (IMS), IP Mobility Management, Session Internet Protocol(SIP) authentication, and online charging for mobile telecommunications as discussed in several 3^{rd} Generation Partnership Project (3GPP) specifications. Telecommunication network elements that use Diameter Application protocols may include, for example, network elements that perform the Online Charging Function(OCF), the Home Subscriber Server(HSS), the Short Message Service Center (SMSC), the Proxy-Call Session Control Function(P-CSCF), the Interrogating Call Session Control Function (I-CSCF), the Serving Call Session Control Function (S-CSCF), the MultiMedia Message Center (MMSC) and the Serving Gateway Support Node (SGSN) elements among others. Prior art also suggests a Relay Agent which accepts and correctly routes messages between Diameter nodes based on information found in the messages. This agent serves to simplify the configuration and routing in a larger network with many elements. In RFC 3588, the relays do not perform any application level processing. In fact the prior art refers to the relay agent as being “largely transparent” and teaches against the relay agent making any modifications to the message other than inserting or removing routing information. This would include addition of a debug application and transformation of the message to human readable format. This implies that the debug of an complicated telecommunications network and associated routing tables is left as a painful task for the telecommunications carrier. Debugging of a diameter application could easily require Insertion of multiple passive stand-alone protocol analyzers in different paths of the network at added capital cost and additional outage time. At a minimum the prior art implies network outage and delay associated with insertion and configuration of independent passive analyzers. Oftentimes this also requires an interruption of correctly routed traffic while the debug equipment is inserted into the network. The enhanced Diameter Gateway apparatus includes Diameter routing as well as Diameter debug capabilities to be used as part of regular operation in a centralized location in the telecommunications network. This enables the operator to more quickly determine routing and other errors in their network and minimize network interruptions.

### SUMMARY OF INVENTION

The Enhanced Diameter Gateway apparatus accepts messages from multiple Diameter network elements, captures and transforms the Diameter information into human readable form and then routes the message in Diameter format to the correct destination.

### DRAWINGS—List of Reference Numbers

EDG Enhanced Diameter Gateway 200

EIR Equipment Identity Register 420

HSS Home Subscriber Server 300

I-CSCF Interrogating Call Session Control Function 340

MME Mobility Management Entity 430

MMSC Multi-Media Message Center 220

OCF Online Charging Function 210

P-CSCF Proxy Call Session Control Function 330

S-CSCF Serving Call Session Control Function 320

SGSN Serving Gateway Support Node 400

### GLOSSARY

3GPP Third Generation Partnership Project

Application Identifier A routing parameter used in Diameter Protocol

AVP Attribute-Value Pair

Destination-Host A routing parameter used in Diameter Protocol

Destination-Realm A routing parameter used in Diameter Protocol

IETF Internet Engineering Task Force

IMS Internet Protocol Multimedia System

IP Internet Protocol

RFC IETF Request for Comments Document

### BRIEF DESCRIPTION OF DRAWINGS

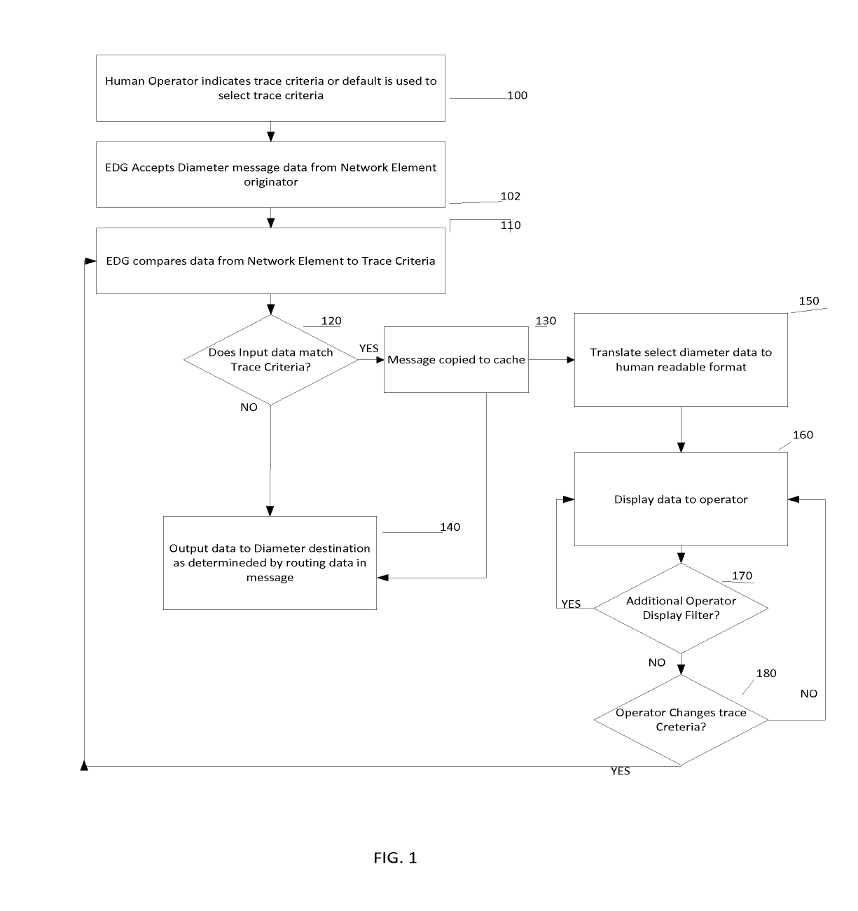

FIG. 1 shows a generic flow chart of a Diameter message through the Enhanced Diameter Gateway (EDG) including real-time capture, translation and display of information to the operator.

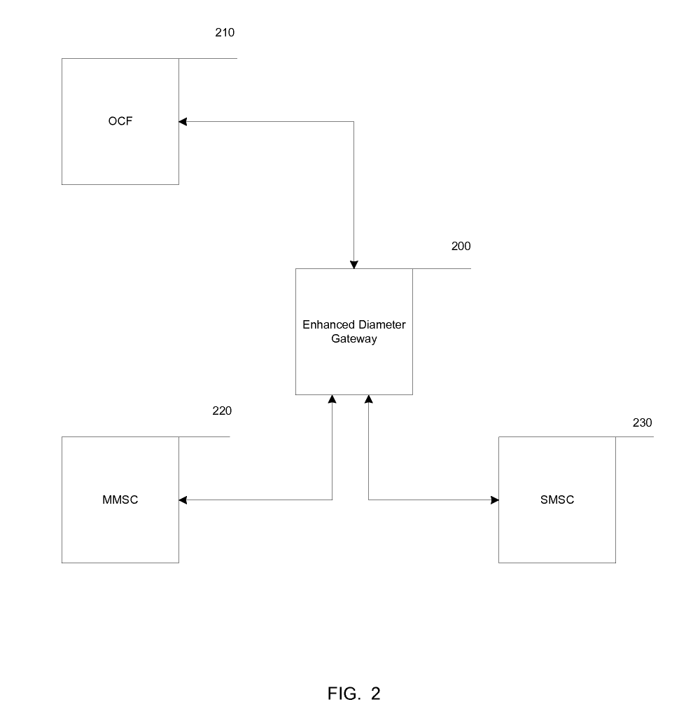

FIG. 2 shows an embodiment where the Enhanced Diameter Gateway is used in conjunction with the 3GPP “Ro” interface. The Enhanced Diameter Gateway is connected to an apparatus that performs an Online Charging Function and the EDG is also connected to a charging entity, for example an SMSC or MMSC. Messages between the MMSC and the Online Charging Function are routed through the Enhanced Diameter Gateway. Messages between the SMSC and the Online Charging Function are also routed through the Enhanced Diameter Gateway.

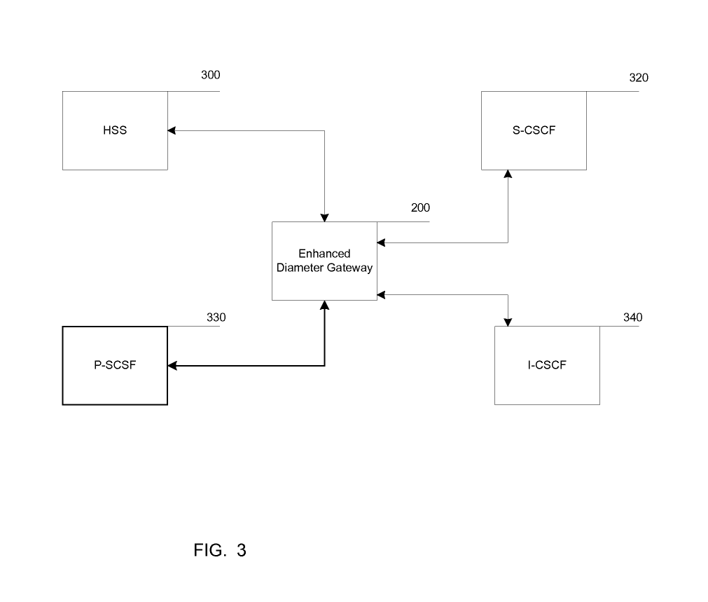

FIG. 3 shows an embodiment where the Enhanced Diameter Gateway is used in conjunction with the 3GPP “Cx” or “Dx” interfaces. The Enhanced Diameter Gateway is connected to and routes messages between an HSS, and other elements including a S-CSCF, a P-CSCF and an I-CSCF network element.

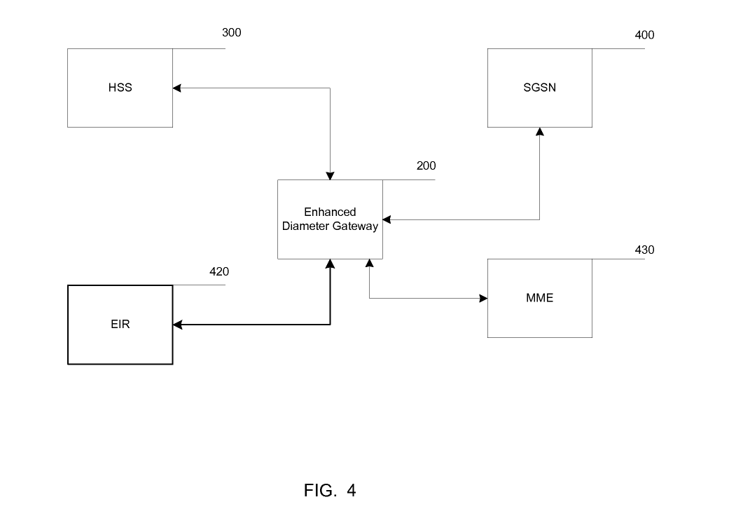

FIG. 4 shows an embodiment where the Enhanced Diameter Gateway is used in the 3GPP “S6a” and “S6d” interfaces. The Enhanced Diameter Gateway is connected to and routes messages between a HSS, and other elements including an SGSN, an EIR and an MME network element.

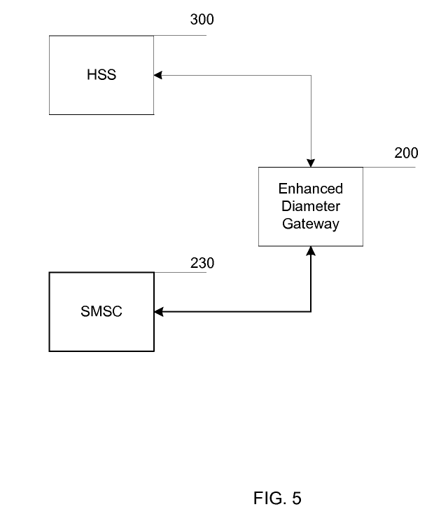

FIG. 5 shows an embodiment where the Enhanced Diameter Gateway is used in the “Sh” interface. The Enhanced Diameter Gateway is connected to and routes messages between a HSS and an application server such as, for example, an SMSC.

### DETAILED DESCRIPTION

In FIG. 1 the Enhanced Diameter Gateway (EDG) accepts trace criteria from an operator or a default trace criteria is used as the trace criteria. A message is then input into the EDG from a network element.

The input message is then compared to the trace criteria. For example the message may meet the trace criteria of a given Destination-Host and Destination-Realm. If the message matches the trace criteria the entire message is copied and stored. All messages, including those copied as well as those not copied are routed to the diameter destination based upon the routing information in the message. Messages which have been copied are translated by the EDG into human readable format. For example, Destination-Host 123456 is translated into “MMSC 1” and Diameter Application ID “16777229” is translated by the EDG into “Charging Function” for purposes of Display. The human readable message is displayed to the operator.

A hex dump of the message or a portion of the message may also be displayed. The operator is given the opportunity to further filter the displayed messages, for example if all messages to a specific Destination_host are captured the operator may choose to display only the messages associated with the online charging function. The operator is also given the opportunity to change the message trace criteria in order to change the messages copied and stored.

In FIG. 2 the EDG is connected to the OCF as well as to other network elements such as the SMSC or the MMSC. In this embodiment, a diameter message such as, for example, the CREDIT-CONTROL-REQUEST message is sent from the MMSC to the OCF by way of the EDG. The EDG receives the message from the MMSC. If the message matches the trace criteria the entire message is copied and stored. Messages which have been copied are translated by the EDG into human readable format. The human readable message is displayed to the operator. The operator is given the opportunity to further filter the displayed messages, for example only display the messages associated with the online charging function. The operator is also given the opportunity to change the message trace criteria in order to change the messages copied and stored. All messages, displayed or not, are routed by the EDG to the proper destination device. In a properly working system, the OCF would then be expected to respond to the MMSC with a CREDIT-CONTROL-ANSWER message routed to the originator of the CREDIT-CONTROL-REQUEST message via the EDG. If the CREDIT-CONTROL-ANSWER also meets the trace criteria, the EDG would display preselected elements for the CREDIT-CONTROL-ANSWER message. The CREDIT-CONTROL-ANSWER message would be routed to it's proper destination, in this case the originating MMSC. In a similar fashion a CREDIT-CONTROL-REQUEST message can also be originated from an SMSC to the OCF with the associated CREDIT-CONTROL-ANSWER message back to the SMSC.

Those skilled in the art will recognize that the EDG could be used in this same embodiment to route and display information on the Diameter Re-Auth-Request Message, the Re-Auth-Answer Message, the Abort-Session-Request Message and the Abort-Session-Answer Message.

In FIG. 3 the EDG is connected to the HSS as well as to the S-CSCF, the I-CSCF and the P-CSCF elements. In this embodiment, A SERVER-ASSIGNMENT-REQUEST message for example is sent from the S-CSCF to the HSS by way of the EDG. The EDG receives the message from the S-CSCF and

If the message matches the trace criteria the entire message is copied and stored. Messages which have been copied and stored are then translated by the EDG into human readable format. The human readable message is displayed to the operator. The operator is given the opportunity to further filter the displayed messages. The operator is also given the opportunity to change the message trace criteria in order to change the messages copied. The message is additionally routed by the EDG to the proper destination device. In a properly working system, the HSS would then be expected to respond to the S-CSCF with a SERVER-ASSIGNMENT-ANSWER message routed to the originating S-CSCF of the SERVER-ASSIGNMENT-REQUEST message via the EDG. If the SERVER-ASSIGNMENT-ANSWER message also meets the trace criteria, the EDG would also display preselected elements for the message.

Those skilled in the art will recognize that the EDG could be used in this same embodiment to route and display information on the User-Authorization-Request, the User-Authorization-Answer, the Location-Info-Request, the Location-Info-Answer, the Multimedia-Auth-Request, Multimedia-Auth-Answer, the Registration-Termination-Request, the Registration-Termination-Answer, the Push-Profile-Request and the Push-Profile-Answer commands.

In FIG. 4 the EDG is connected to the HSS as well as to the SGSN, the EIR and the MME elements. In this embodiment, a INSERT-SUBSCRIBER-DATA-REQUEST message for example is sent from the SGSN or MME to the HSS by way of the EDG. The EDG receives the message from the SGSN and

If the message matches the trace criteria the entire message is copied and stored. Messages which have been copied are then translated by the EDG into human readable format. The human readable message is displayed to the operator. The operator is given the opportunity to further filter the displayed messages. The operator is also given the opportunity to change the message trace criteria in order to change the messages copied and stored. The message is additionally routed by the EDG to the proper destination device. In a properly working system, the HSS would then be expected to respond to the SGSN with a INSERT-SUBSCRIBER-DATA-ANSWER message routed to the originating SGSN via the EDG. If the INSERT-SUBSCRIBER-DATA-ANSWER message also meets the trace criteria, the EDG would display the preselected elements for the message.

In a similar fashion this embodiment can be also used by the MME to send an ME-IDENTITY-CHECK-REQUEST from the MME to the EIR by way of the EDG. The EDG receives the message from the MME and

If the message matches the trace criteria the entire message is copied and stored. Messages which have been copied are then translated by the EDG into human readable format. The human readable message is displayed to the operator. The operator is given the opportunity to further filter the displayed messages. The operator is also given the opportunity to change the message trace criteria in order to change the messages copied. The message is additionally routed by the EDG to the proper destination device. In a properly working system, the EIR would then be expected to respond to the MME with a ME-IDENTITY-CHECK-ANSWER message routed to the originating MME via the EDG. If the ME-IDENTITY-CHECK-ANSWER message also meets the trace criteria, The EDG would display any preselected elements for the message.

Those skilled in the art will recognize that the EDG could be used in this same embodiment to route and display information on the Update-Location-Request, Update-Location-Answer, Authentication-Information-Request, Authentication-Information-Answer, Cancel-Location-Request, Cancel-Location-Answer, Delete-Subscriber-Data-Request, Delete-Subscriber-Data-Answer, Purge-UE-Request, Purge-UE-Answer, Reset-Request, Reset-Answer, Notify-Request, and Notify-Answer Diameter commands

In FIG. 5, the EDG is connected to the HSS as well as to a 3GPP “Application Server” device such as an SMSC. In this embodiment, a USER-DATA-REQUEST message for example is sent from the SMSC to the HSS by way of the EDG.

The EDG receives the message from the SMSC and If the message matches the trace criteria the entire message is copied and stored. Messages which have been copied are then translated by the EDG into human readable format. The human readable message is displayed to the operator. The operator is given the opportunity to further filter the displayed messages. The operator is also given the opportunity to change the message trace criteria in order to change the messages copied. The message is additionally routed by the EDG to the proper destination device. In a properly working system, the HSS would then be expected to respond to the SMSC with a USER-DATA-ANSWER message routed to the originating SMSC via the EDG. If the USER-DATA-ANSWER message also meets the trace criteria. The EDG would display the Destination-Host, the Destination-Realm and any other preselected elements for the message.

Those skilled in the art will recognize that the EDG could be used in this same embodiment to route and display information on the Profile-Update-Request, Profile-Update-Answer, Subscribe-Notifications-Request, Subscribe-Notifications-Answer, Push-Notification-Request, and Push-Notification-Answer Diameter commands.

1. An apparatus that accepts messages in Diameter format from at least one source, transforms all or a portion of the messages into human readable format in real-time, and also routes the messages to at least one destination in Diameter format.

2. The apparatus of claim 1 that allows a human operator to preselect characteristics of messages that are to be captured in real-time.

3. The apparatus of claim 2 that allows a human operator to further filter the message to be displayed.

4. The apparatus of claim 1 that transforms attribute-value pairs into human readable format.

5. The apparatus of claim 1 that transforms the routing data portion of the message into human readable format.

6. The apparatus of claim 5 that displays the Destination-Host into human readable format.

7. The apparatus of claim 5 that displays the Destination -Realm into human readable format.

8. The apparatus of claim 5 that displays the Application Identifier into human readable format.
